(19) United States
(12) Patent Application Publication
(10) Pub. No.: US 2014/0250205 A1
(43) Pub. Date: Sep. 4, 2014

(54) Test management

(71) Applicant: iStoc Oy, Oulunsalo (FI)

(72) Inventors: Hannu KAUNISKANGAS, Oulunsalo (FI); Jarmo JARVENPAA, Oulunsalo (FI)

(73) Assignee: iStoc Oy, Oulunsalo (FI)

(21) Appl. No.: 14/190,425

(22) Filed: Feb. 26, 2014

(30) Foreign Application Priority Data
Mar. 4, 2013 (FI) 20135203

(51) Int. Cl. H04L 29/08

(52) U.S. Cl. CPC H04L 67/16
USPC 709/217

(57) ABSTRACT

A method and a computing resource (110) are disclosed. The solution includes receiving (902) from at least one mobile test reader apparatus, information related to at least one test structure used in a lateral flow test controlled by the mobile test reader apparatus; receiving (904) from at least one external entity related to the tests, analysis results and feedback related to the at least one test structure; storing and combining (906) information related to the at least one test structure to obtain processed data and transmitting (908) processed data to at least one external entity related to tests.

### FIELD

The invention relates to data processing in a computing resource related to lateral flow tests.

### BACKGROUND

Tests such as lateral flow tests are read with manufacturer-specific readers, but more generic apparatuses are currently emerging, one example being described in WO 2012/131386.

Controlling and managing testing and processing test results related to tests performed in varying geographical locations and varying conditions is a challenging task.

Currently, a lateral flow test manufacturer delivers a test strip or a test structure batch to a test operator. The test operator manages test structured to be used in the field by a test reader users. The tests may be related to diseases or other health related issues such as water purity, for example. The test reader can be a dedicated device for testing certain test strips or it is a configurable device such as a mobile phone having possibility to receive instruction online and send data results online and add also location information to the data.

As soon as a test sample has been taken and set to a test structure strip, the test structure will be read by a test reader operated by a test reader user. The test reader can do a test result analysis and report the result immediately or it obtain a preliminary test result and send the test data to the server which process the data further. The server can analyze the results more and give final results or send it for the expert partner such as a heath care specialist who can do the final test analysis and report it or confirm the result made earlier by a test reader or the server.

The server may receive information from test reader, forward data to an expert partner and keep a database of results but it present solutions is just collecting the date and keeping data as a backup memory if needed to return it later.

The current process is lacking of proper control of process as there is no way to manage how the testing process is going through from the reading the test sample to the final analysis of the test results and how the test results is then communicated and possible care actions taken.

### BRIEF DESCRIPTION

The present invention seeks to provide an improved solution for managing and processing data related to lateral flow tests.

According to an aspect of the present invention, there is provided a computing resource comprising a data communication interface, one or more processors, and one or more memories including computer program code, the one or more memories and the computer program code configured to, with the one or more processors, cause the computing resource at least to perform: receive with the data communication interface from two or more mobile test reader apparatuses, information related to at least one test structure used in a lateral flow test controlled by the mobile test reader apparatus; receive with the data communication interface from at least one external entity related to the tests, analysis results and feedback related to the at least one test structure; store and combine information related to the at least one test structure to obtain processed data; transmit with the data communication interface processed data to at least one external entity related to tests.

According to another aspect of the present invention, there is provided a method, comprising: receiving from two or more mobile test reader apparatuses, information related to at least one test structure used in a lateral flow test controlled by the mobile test reader apparatus; receiving from at least one external entity related to the tests, analysis results and feedback related to the at least one test structure; storing and combining information related to the at least one test structure to obtain processed data; transmitting processed data to at least one external entity related to tests.

### LIST OF DRAWINGS

Example embodiments of the present invention are described below, by way of example only, with reference to the accompanying drawings, in which

FIG. 1 illustrates an example embodiment of a general operating environment;

FIG. 2 illustrates example embodiments of a test structure;

FIG. 3 illustrates example embodiments of an external entity;

FIGS. 4 and 5 illustrate example embodiments of a mobile test reader;

FIG. 6 is a signalling chart illustrating an example of communication between different elements of the general operating environment;

FIG. 7 illustrates example embodiments of an external entity and a computing resource;

FIG. 8 illustrates an example embodiment of a computing resource;

FIG. 9 illustrates an example embodiment of a method; and

FIG. 10 illustrates further example embodiments of a mobile test reader, an external entity and a computing resource.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments of apparatuses, they are simplified block diagrams that only show some structures and functional entities. The connections shown in these Figures are logical connections; the actual physical connections may be different. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses may also comprise other functions and structures. It should be appreciated that details of some functions, structures, and the protocols used for communication are irrelevant to the actual invention. Therefore, they need not be discussed in more detail here. Although the apparatuses have been depicted as separate single entities, different parts may be implemented in one or more physical or logical entities.

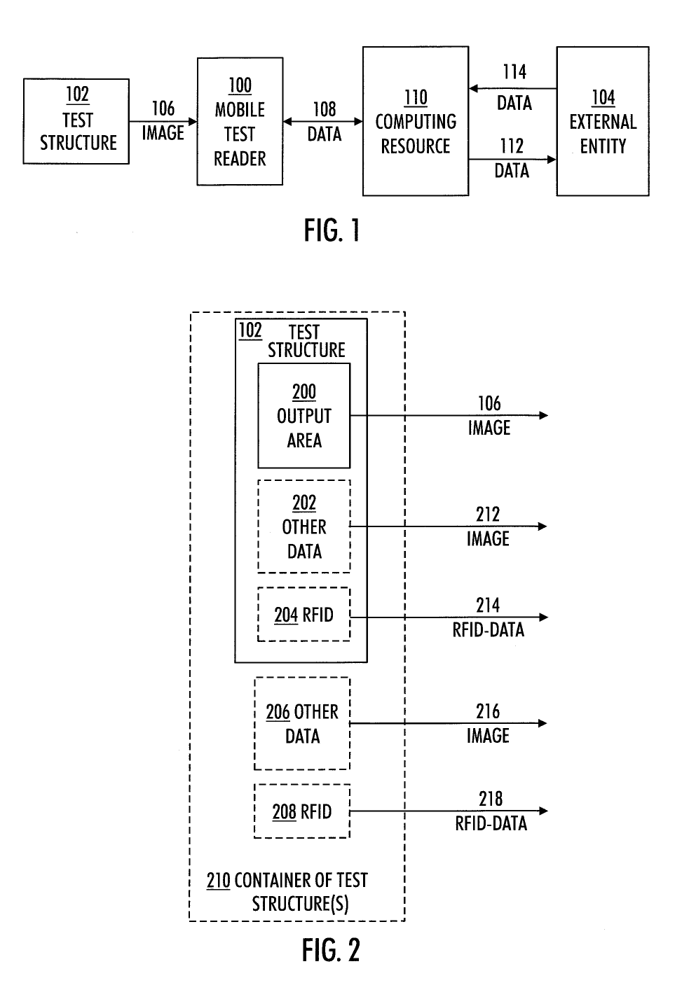

FIG. 1 illustrates an example embodiment of a general operating environment. A mobile test reader 100 takes an image 106 of a test strip or test structure 102. Furthermore, the mobile test reader 100 communicates data 108 relating to the test 102 with a computing resource 110. The external entities may be configured to transmit data 114 related to tests to the computing resource 110. The computing resource is configured to receive the data, store and combine data and send processed data 112 to one or more external entities 104.

FIG. 2 illustrates example embodiments of the test strip or test structure 102. The test structure 102 is capable of measuring a certain property of a target analyte in a sample. In its simplest form, the test 102 is capable of detecting the presence (or absence) of the target analyte in the sample. As the test structure 102 is usually relatively simple and cheap, it may be used for various diagnostics at home or in the field, for example, but also in clinics and laboratories.

The test structure 102 may be applied to human or animal secretions such as urine, saliva, blood, or stool samples, or also to other substances such as food or water. Accordingly, the test structure 102 may be utilized for medical testing of humans or animals, or testing food and water for contaminants, ingredients and/or traces of other substances, for example.

In an embodiment, the test structure 102 is a (clinical) point of care test for pregnancy, fertility, human immunodeficiency virus HIV, coronary artery disease, malaria, drug abuse, respiratory disease, or for some other medical condition.

In an embodiment, the test structure 102 may be used for a lateral flow test (also known as a lateral flow immunochromatographic assay).

The test structure 102 comprises an output 200 whose visual appearance changes to show the result of the test in the form of an image 106. In the lateral flow test structure 102, the output area 200 may comprise at least one stripe, coupled by at least one capillary bed to a conjugate, the stripe changing colour as a result of a specified reaction between a target molecule in the sample and its chemical partner in the conjugate. The reaction may be chemical.

In an embodiment, the test structure 102 may also be hierarchical, meaning that it may include more than one parallel tests, and even that one or more of the parallel tests may in turn include a number of subtests.

In an embodiment, besides being the lateral flow test, the test structure 102 may be any test of at least one such chemical property that affects the visual appearance of the output 200.

In an embodiment, the test structure 102 may also comprise, besides the output 200, other data 202 that may be inspected visually in the form of an image 212.

In an embodiment, the test structure 102 may also comprise a radio frequency identifier (RFID) tag 204 capable of storing data that may be read 214 wirelessly.

In an embodiment, a container 210 of the test structure 102 may comprise other data 206 that may be visually inspected in the form of an image 216, and/or a radio frequency identifier tag 208 capable of storing data that may be read 218 wirelessly. The container 210 may contain only one test structure 102 or a specific number of test structures 102. The container may comprise a carton.

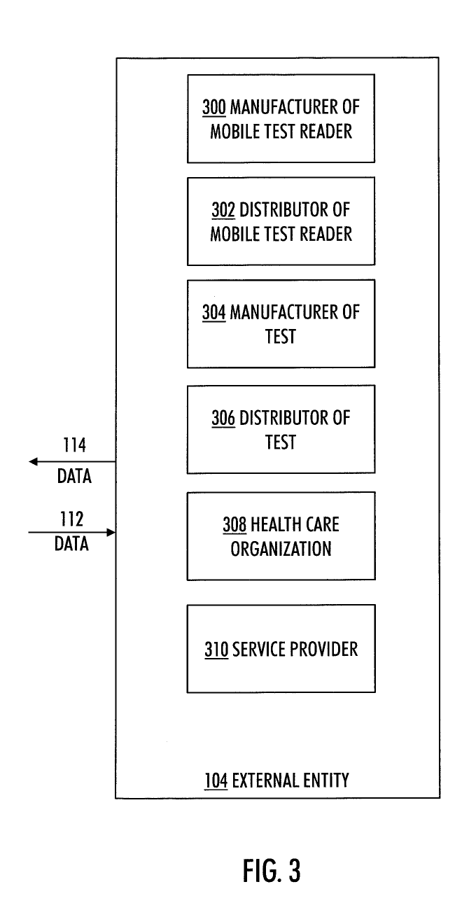

FIG. 3 illustrates example embodiments of the external entity 104. The term “external entity” 104 refers to any interest group or a computing resource controlled by an interest group having a legitimate interest in the use of the test structure 102 and/or to any technical counterpart of the mobile test reader 100. Accordingly, a non-exhaustive list of the external entity 104 comprises at least one of the following: a manufacturer 300 of the mobile test reader 100, a distributor 302 of the mobile test reader 100, a manufacturer 304 of the test structure 102, a distributor 306 of the test structure 102, a health-care organization 308, a service provider 310.

In an embodiment, the external entity 104 comprises one or more computing resources controlled by one or more entities described above. The computing resources may be realized with one or more servers, cloud computing or any other technical realization. Naturally, the desired operating environment determines the rights of the various interest groups and the properties of the selected technical counterparts.

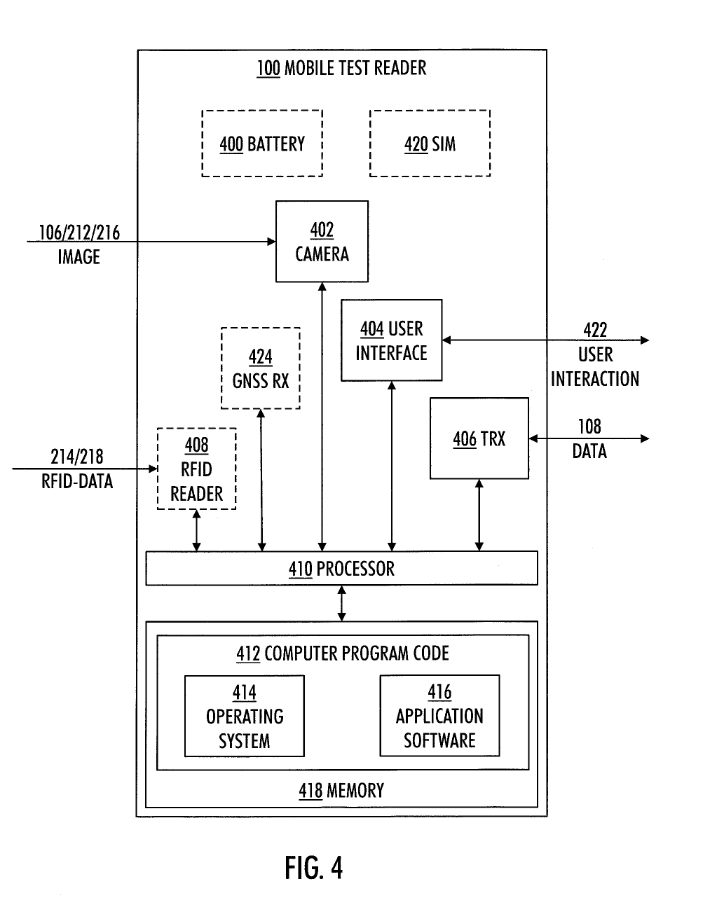

FIG. 4 illustrates some example embodiments of the mobile test reader 100. The mobile test reader 100 may be any suitable mobile electronic apparatus. A non-exhaustive list of the types of the apparatus 100 includes: a mobile phone, a smartphone, a tablet computer, a general-purpose mobile computing device. In an example embodiment, the mobile test reader 100 is a general-purpose off-the-shelf computing device, as opposed to a purpose-build proprietary test reader, whereby research & development costs will be lower as only the special-purpose software (and not the hardware) needs to be designed, implemented and tested.

The mobile test reader 100 may comprise a battery 400, a digital camera 402, a user interface 404, a wireless transceiver 406, and a radio-frequency identifier reader 408.

In an embodiment, the (rechargeable) electrical battery 400 is one or more electrochemical cells that convert stored chemical energy into electrical energy. Instead of battery 400, other suitable accumulator means may be used to store energy.

In an embodiment, the digital camera 402 takes video or still photographs by recording images on an electronic image sensor through an optical system.

In an embodiment, the user interface 404 implements the exchange 422 of graphical, textual and auditory information with the user of the mobile test reader 100. The user interface 404 may be realized with various techniques, such as a display, means for producing sound, a keyboard, and/or a keypad, for example. The display may be a liquid crystal display, for example, but it may also be implemented by any appropriate technique, such as with an active-matrix organic light-emitting diode. The display may also incorporate other user interaction means, such as touch input, or haptic feedback, i.e. the display may be a touch screen. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, the user interface 404 may comprise other user interface components, for example various means for focusing a cursor (mouse, track ball, arrow keys, touch sensitive area etc.) or elements enabling audio control.

In an embodiment, the wireless transceiver 406 may be interoperable with various wireless standard/non-standard/proprietary communication networks such as any mobile phone network, regardless of the generation (such as 2G, 3G, 4G, beyond 4G, etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), such as WLAN (Wireless Local Area Network) based on IEEE (Institute of Electrical and Electronics Engineers) 802.11 standard or its evolution versions (IEEE 802.11ac etc.), WiMAX (Worldwide Interoperability for Microwave Access, or Wi-Fi, for example.

In an embodiment, the wireless transceiver 406, while communicating with a mobile phone network, may require a subscriber identity module (SIM) 420, which may be an integrated circuit storing subscriber data, which is network-specific information used to authenticate and identify subscribers on the cellular network. The subscriber identity module may be embedded into a removable SIM card, on a mini-SIM card, for example. Furthermore, the mobile test reader 100 may include a SIM card reader (not illustrated in FIG. 4), for example. Besides being implemented on a SIM card, the subscriber identity module 420 may be implemented with other techniques as well, such as a virtual/embedded SIM.

In an embodiment, the mobile test reader 100 includes a RFID reader 408 capable of reading RFID data 214, 218 programmed into the electronic tag 204, 208 of the test structure 102 or its container 210. The reader 408 reads 214, 218 the data from the tag 204, 208 with radio waves. The tag 204, 208 may comprise at least two parts: an integrated circuit for storing and processing information, modulating and demodulating a RF signal, and other specialized functions, and an antenna for receiving and transmitting the signal. The tag 204, 208 may be passive (using no battery), active (with a battery and always broadcasting its signal) or battery assisted passive (with a battery and activated by the presence of the reader 408). In an example embodiment, near field communication (NFC) may be utilized. NFC is a set of standards for smartphones and similar devices to establish radio communication with each other by touching them together or bringing them into close proximity. NFC utilizes various short-range wireless technologies, typically requiring a distance of four centimetres or less. In NFC, the reader 408 is also known as an initiator generating a radio frequency field powering and reading 214, 218 the data from the external object 204, 208 also known as a passive target.

The mobile test reader 100 also comprises one or more processors 410, and one or more memories 418 including computer program code 412.

In an embodiment, the term ‘processor’ 410 refers to a physical device that is capable of processing data in a computer or other digital electronic device. Depending on the processing power needed, the mobile test reader 100 may comprise several processors 410 such as parallel processors or one or more multicore processors. A non-exhaustive list of implementation techniques for the processor 410 includes, but is not limited to: logic components, standard integrated circuits, application-specific integrated circuits (ASIC), system-on-a-chip (SoC), application-specific standard products (ASSP), microprocessors, digital signal processors, special-purpose computer chips, and field-programmable gate arrays (FPGA).

In an embodiment, the term ‘memory’ 418 refers to a physical device that is capable of storing the computer program code 412 and data on a temporary or permanent basis for use in a computer or other digital electronic device. In an example embodiment, the term ‘memory’ refers to working memory (also known as primary storage, main memory or internal storage) directly accessible to the processor. In an example embodiment, the working memory may be implemented as a random-access memory (RAM), such as a dynamic RAM, DRAM.

In an embodiment, the computer program code 412 includes an operating system 414 and application software 416. The operating system may be Android, Microsoft Windows Phone, Apple iOS, Linux, or Symbian, for example. The application software 416 includes all the applications running in the mobile test reader 100.

Naturally, the mobile test reader 100 may include a number of other components, but as they are not required to illustrate the present embodiments, they will not be further described.

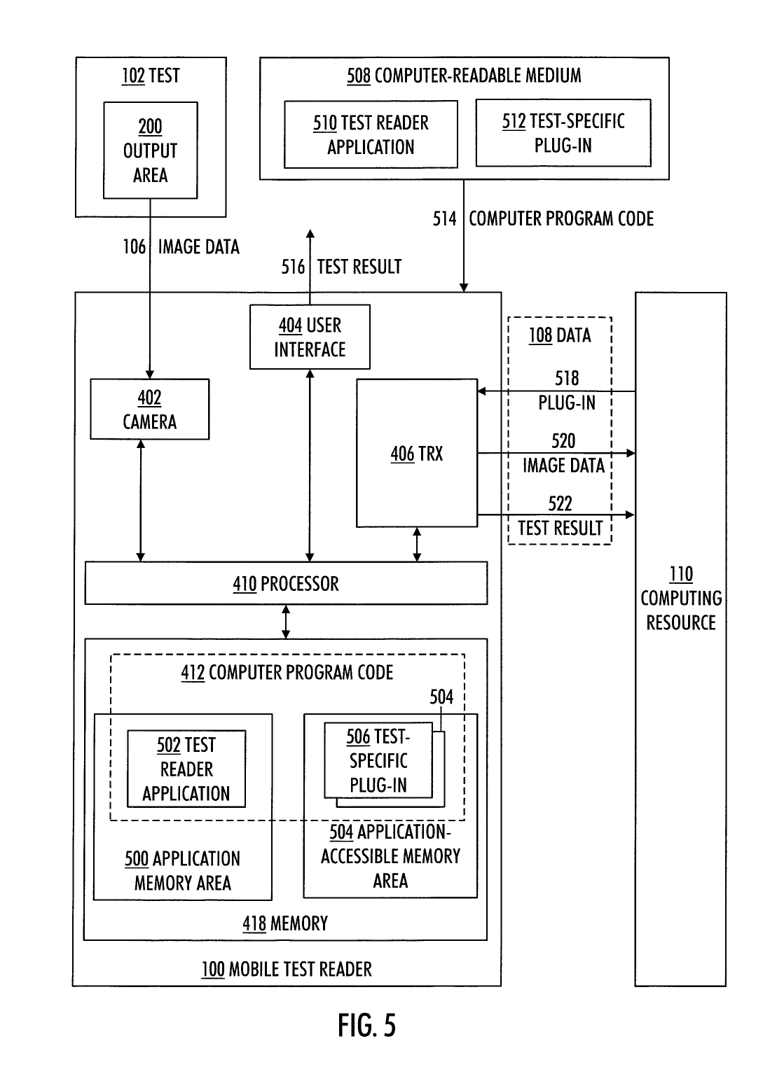

Let us next study FIG. 5, illustrating further example embodiments of the mobile test reader 100, especially the way the mobile test reader 100 interacts with the test 102 and the computing resource 110.

In an embodiment, the one or more memories 418 and the computer program code 412 are configured to, with the one or more processors 410, cause the mobile test reader 100 to receive, with the wireless transceiver 406, a test-specific or test structure specific plug-in 518 from the computing resource 110, to configure a test reader application 502 with the received test-specific or test structure specific plug-in 506, and to take, with the digital camera 402 controlled by the test reader application 502 configured with the test-specific or test structure specific plug-in 506, image data 106 depicting the output area 200 of the test structure 102.

With this mechanism, the test reader application 502 may be configured with various test-specific or test structure specific plug-ins 506, 504, i.e., the memory 418 may contain different test-specific or test structure specific plug-ins, one for each different type of test structure 102.

In an embodiment, the plug-in 506 comprises at least some of the following information:
an image taking instruction for taking of the image data 106 with the digital camera 402, the image taking instruction comprising at least one of the following: manual/automatic mode, focus distance, location, focus, lighting, shooting angle;
an analysis instruction for analysis of the output 200, the analysis instruction comprising at least one of the following: optical readability, colour info, ratiometric numbers, a test limit parameter, a test criteria, a test reliability parameter, a test quality parameter, a test validity parameter;
general information on the test structure 102, the general information comprising at least one of the following: an identifier of a manufacturing batch of the test structure 102, a manufacturer identifier, a manufacturing date of the test structure 102, information on the quality of the production batch of the test structure 102, information on the use by date of the test structure 102, information on the dimensions or relative dimensions of the output 200, information on the dimensions or relative dimensions of the test structure 102.

Naturally, the above described information for the plug-in 506 is just a non-limiting example embodiment. Furthermore, the following information may or may not be present in the plug-in: a test structure 102 identifier, a name for the test structure 102, a name in the local language(s) for the test structure 102, an image analysis algorithm, a flashlight instruction (on/off/intensity), a bounding box (=an area within which the output 200 is searched for), size and location of an aiming crosshair (or box, or other aiming aid) for the output 200, size of the output 200 in pixels, a minimum and maximum aspect ratio between the breadth and height of the output 200, a minimum and maximum intensity of the stripe(s) in the output 200, location of the stripe(s) in the output 200, a reliability threshold for successive similar video frames, a maximum allowable deviation for the shooting angle in roll and pitch directions, an offset for said maximum allowable deviation, test structure 102 interpretation rules, workflow rules for the test structure 102. The workflow rules for the test structure 102 may include various information relating to the correct workflow of the testing procedure. The workflow rule may determine that the test structure 102 result needs to be read after a predetermined time period (5 minutes, for example) from the insertion of the sample in the test structure 102. The workflow rule may determine when the test result may be shown to the user: immediately, or after a medical doctor or other authority has examined the test structure 102 result.

Furthermore, in an example embodiment, the one or more memories 418 and the computer program code 412 are further configured to, with the one or more processors 410, under the control of the test reader application 502 configured with the plug-in 506, cause the mobile test reader 100 further to perform at least one of the following: transmit, with the wireless transceiver 406, the image data 520 to the computing resource 110; generate, with the test reader application 502 configured with the plug-in 506, a test result for the test structure 102 on the basis of the image data 106; transmit, with the wireless transceiver 406, the test result 522 to the computing resource 110; output, with the user interface 404, the test result 516. This means that the mobile test reader 100 may just transmit the image data 520 to the computing resource 110, whereupon the computing resource 110 may generate the test result. Or it may mean that the test result is generated in the mobile test reader 100, and the test result is shown to the user and/or transmitted to the external entity 104. Even though the test is generated in the mobile test reader 100, the image data 520 may still be transmitted to the computing resource 110 as well.

In an embodiment, the one or more memories 418 comprises an application memory area 500 and an application-accessible memory area 504. The computer program code of the test reader application 502 may be stored in the application memory area 500. The one or more memories 418 and the computer program code 412 may further be configured to, with the one or more processors 410, cause the mobile test reader 100 to store the received plug-in 506 in the application-accessible memory area 504.

An example embodiment, illustrated in FIG. 5, provides a computer readable medium 508 comprising the computer program code 412 of the test reader application 510 and the test-specific or test structure specific plug-in 512. Said computer program code 412, when executed on the mobile test reader 100, causes the mobile test reader 100 to perform the operations required to implement the described example embodiments. In an example embodiment, the computer program code 412 may be in source code form, object code form, or in some intermediate form. The computer-readable medium 508 may comprise at least the following: any entity or device capable of carrying 514 computer program code 412 to the mobile test reader 100, a record medium, a computer memory, a read-only memory, an electrical carrier signal, a telecommunications signal, and a software distribution medium. In an example embodiment, the computer-readable medium 508 may be a non-transitory computer readable storage medium.

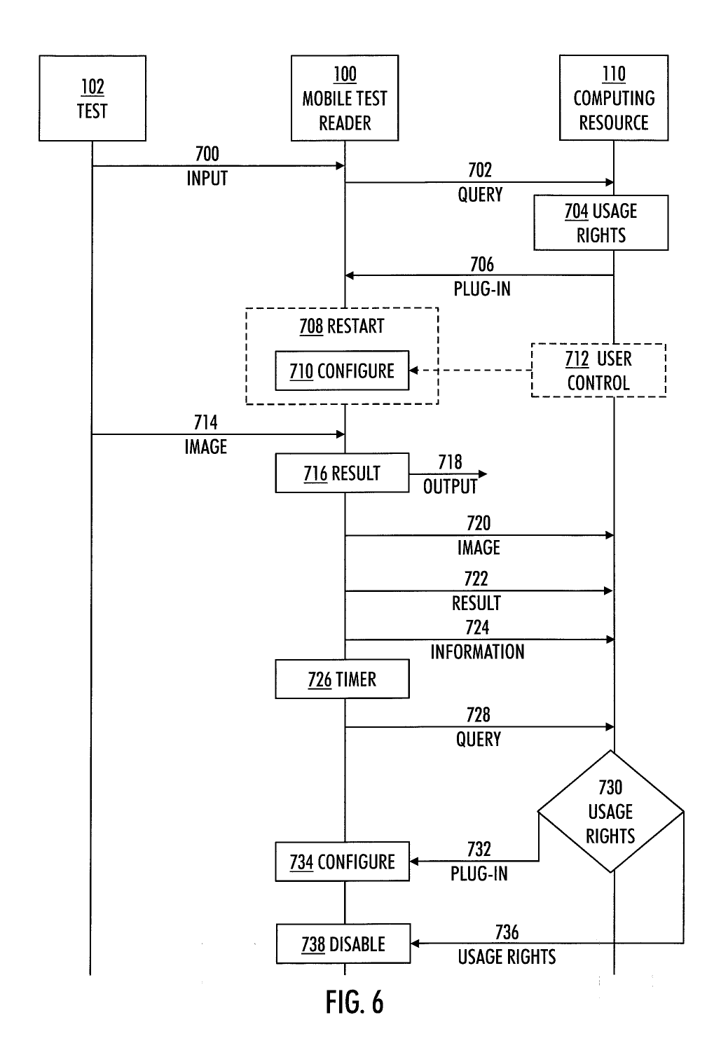

Next, with reference to FIG. 6, let us study the communication of the mobile test reader 100 and some further example embodiments in the form of a signal sequence chart. Other functions, not described in this application, may also be executed between the operations or within the operations. Some of the operations or parts of the operations may also be left out or replaced by a corresponding operation or part of the operation.

In an example embodiment, the mobile test reader 100 inputs 700, with the digital camera 402 or with the user interface 404, or with a wireless reading (with the RFID reader 408), an identifier of the test structure 102 and/or type of the test structure 102 to the test reader application 502.

In an example embodiment, the mobile test reader 100, prior to receiving the plug-in 506 from the computing resource 110, transmits 702, with the wireless transceiver 406, a query to the computing resource 110 regarding the test-specific plug-in 506, the query including the present status of the test-specific or test structure specific plug-in 506, the present status indicating the presence of the test-specific or test structure specific plug-in 506, and/or or the version number of the test-specific or test structure specific plug-in 506. If the test-specific or test structure specific plug-in 506 is present, the version number may be transmitted, but if the plug-in is missing, only the presence information may be transmitted.

In an example embodiment, the mobile test reader 100 transmits, with the wireless transceiver 406, information relating to the mobile test reader 100 to the computing resource 110, the information relating to the mobile test reader 100 including at least one of the following: type of the mobile test reader 100, location of the mobile test reader 100, local time of the mobile test reader 100, information on the climatic conditions surrounding the mobile test reader 100.

As illustrated in FIG. 4, in order to determine its location, the mobile test reader 100 may comprise a positioning receiver 424 receiving external location information, which may be utilized to generate location of the mobile test reader 100. The positioning receiver 424 may be a receiver of a global navigation satellite system (GNSS). Such a system may be the Global Positioning System (GPS), the Global Navigation Satellite System (GLONASS), the Galileo Positioning System (Galileo), the Beidou Navigation System, The Quasi-Zenith Satellite System (QZSS), or the Indian Regional Navigational Satellite System (IRNSS), for example. The positioning receiver 424 determines its location (longitude, latitude, and altitude) using signals transmitted from satellites orbiting the earth. Besides global navigation satellites, the positioning receiver 424 may also determine its location by utilizing other known positioning techniques. It is well known that by receiving radio signals from several different base stations, a mobile phone may determine its location, for example.

FIG. 6 also illustrates the earlier described basic sequence: the mobile test reader 100 receives 706, with the wireless transceiver 406, the test-specific or test structure specific plug-in 518 from the computing resource 110, configures 710 the test reader application 502 with the received plug-in 506, and takes 714, with the digital camera 402 controlled by the test reader application 502 configured with the plug-in 506, image data 106 depicting the output 200 of the test structure 102.

It is to be noted, as was explained earlier, that in an example embodiment the mobile test reader 100 stores the received plug-in 506 in the application-accessible memory area 504 without having to exercise any control 712 by an authority other than the user of the mobile test reader 100. The mobile test reader 100 also configures in an example embodiment the test reader application 502 with the test-specific or test structure specific plug-in 506 without having to restart 708 the mobile test reader 100 and/or the test reader application 502. Accordingly, reference numerals 708 and 712 depict such operations that are not required at all in certain example embodiments.

The earlier described basic sequence continues in FIG. 6 as follows: the mobile test reader 100, under the control of the test reader application 502 configured with the plug-in 506, performs at least one of the following: transmits 720, with the wireless transceiver 406, the image data 520 to the external entity 104; generates 716, with the test reader application 502 configured with the plug-in 506, a test result for the test structure 102 on the basis of the image data 106; transmits 722, with the wireless transceiver 406, the test result 522 to the computing resource 110; outputs 718, with the user interface 404, the test result 516. As was explained earlier, also other information 724 may be transmitted from the mobile test reader 100 to the computing resource 110.

In an example embodiment, the mobile test reader 100 receives 706, with the wireless transceiver 406, the newest version of the plug-in 506, and configures 710 the test reader application 502 with the newest version of the plug-in 506.

The configuring of the test reader application 502 with the plug-in 506 may be performed as required. When the mobile test reader 100 prepares for reading the test structure 102, it queries 702 the computing resource 110 for the test-specific plug-in 506, either for the first time, or for the latest version. FIG. 6 also illustrates another example embodiment, the mobile test reader 100 may include a timer mechanism 726, with which the mobile test reader 100 is able to query for the newest version of the plug-in at predetermined intervals (every five minutes, for example) or at predetermined times (once a day or week at noon, for example). The computing resource 110 may also transmit the plug-in 506 to the mobile test reader 100 without any stimulus received from the mobile test reader 100, with a push mechanism, for example.

In an example embodiment, the mobile test reader 100 manages, with the test reader application 502 the usage rights 704, 730 of the test structure 102 such that the plug-in 506 is removed if no usage rights exist for the test structure 102 on the basis of information received from the computing resource 110 with the wireless transceiver 406.

In an example embodiment, the mobile test reader 100 transmits 728, with the wireless transceiver 406, hardware identifier of the mobile test reader 100 and/or user account information of the user of the mobile test reader 100 to the computing resource 110, and receives 732/736, with the wireless transceiver 406, usage rights of the test-specific or test structure specific plug-ins 506, 504.

In an example embodiment, the computing resource 110 keeps 730 track of the usage rights of the test structure 102, whereby, if the usage rights exists, the computing resource 110 transmits 732 the test-specific or test structure specific plug-in to the mobile test reader 100, whereupon the mobile test reader 100 configures 734 the test reader application 502 with the plug-in 506, or, if the usage rights do not exist, the computing resource 110 only transmits 738 usage rights information to the mobile test reader 100, whereupon the mobile test reader 100 disables 738 the plug-in 506, if such is present in the mobile test reader 100. The disable-function 738 may just make the plug-in 506 inoperable, or it may remove the plug-in 506 altogether.

In an embodiment, the mobile test reader 100 calculates a check-sum for the present test-specific or test structure specific plug-ins 506, 504, and the check-sum is transmitted to the computing resource 110. The computing resource 110 maintains an account for each mobile test reader 100, i.e. usage rights of each mobile test reader 100 for the plug-ins 506, 504. If the check-sum that is in the account matches with the check-sum that is received from the mobile test reader 100, the computing resource 110 determines that no update is required. However, if the check-sums do not match, the computing resource 110 initiates the required operations as regards to the usage rights: either a new plug-in is transmitted to the mobile test reader 100, some or all plug-ins are updated, or one or more plug-ins are made inoperable or even removed from the mobile test reader 100, for example.

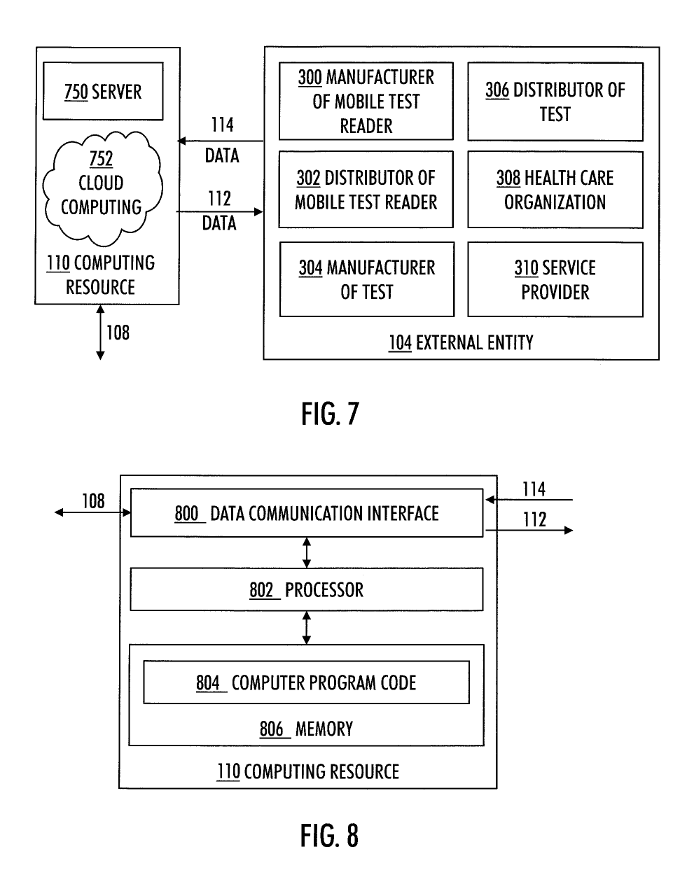

FIG. 7 illustrates example embodiments of the external entity 104 and the computing resource 110. The external entity 104 has already been illustrated in FIG. 3, but now the external entity 104 and the computing resource 110 have been separated to obtain further technical advantages. The term “external entity” 104 refers to any interest group having a legitimate interest in the use of the test structure 102, but the term “computing resource” 110 refers to any technical counterpart of the mobile test reader 100.

The computing resource 110 may be implemented as a single server computer 750 or as a cluster of computers. The server 750 may be a part of the client-server computing model that acts as distributed application which partitions tasks or workloads between the provider of a resource or service, called server 750, and the service requester, called client. The server 750 may serve both the mobile test reader 100 and the external entity 104. The computing resource 110 may also operate according to the cloud computing model 752.

Additionally, or alternatively, the computing resource 110 may also operate according to the peer-to-peer (P2P) computing model. A pure peer-to-peer system consists of equal peer nodes that simultaneously function as both clients 100 and servers 750. In a hybrid peer-to-peer system, a need for a special role is recognized: one or several nodes, but not all nodes, have a special role, which serves the other nodes of the peer-to-peer system. In FIG. 8, the server 110 may have the special role serving the client 100. Additionally, the client 100 may also serve as a server to another client 100.

Naturally, besides these example embodiments of the computing resource 110, other feasible computing architectures may be utilized as well to implement the hardware and software of the computing resource 110. Consequently, besides operating according to the client/server architecture, push technology may be utilized as well. In push technology, the request for a transaction is initiated by the server 750, whereas with the pull technology the request for the information is initiated by the client 100, 104.

As illustrated in FIG. 8, the computing resource 110 may comprise a data communication interface 800, one or more processors 802, and one or more memories 806 including computer program code 804.

The data communication interface 800 may utilize wireless and/or wired network interface technology. Consequently, the data communication interface 800 may comprise a network interface card (also known as a network interface controller, a network adapter, or a LAN adapter) which couples the server computing resource to a telecommunications network. In an example embodiment, the data communication interface 800 operates according to the Ethernet standard, TCP/IP or some other telecommunications standard. Alternatively or additionally, the data communication interface 800 may be interoperable with a cellular network, in which case the data communication interface 800 implements a radio modem capable of sending and receiving text messages, and/or transmitting packet data, over a radio link. Either way, the data communication interface 800 may allow access to the Internet.

As was explained earlier, the test structure 102 may comprise chemical substances that will age, and as a result of the aging, the test criteria may change or become invalid. Accordingly, the test structures 102 need to be manufactured under a strict quality control, so that every manufacturing batch will fulfil the set criteria. Due to the nature of the test substances (mostly organic) and substrate material (paper) there is a natural variation from one manufacturing batch to another batch. Likewise there is variation between test structures manufactured by different manufacturers.

Monitoring the quality of the test structures, the use of the test structures and the test results over time is therefore important.

Currently the test structure manufacturers can only see how many test structures are sold to different channels and users. There is increasing need to know how those tests are used and where, and when.

In the proposed solution, test results are all tagged with location info and this information is stored in the computing resource 110 along with the test results. Furthermore, the test results tagged to a world or local map is interesting to the health organizations and authorities. The follow up of tests done, their success and quality can be controlled.

In an embodiment, the computing resource 110 is configured to collect test structure and test related information, including the location (where the data has been measured) information, about many LFA tests read by many mobile test readers, and process data so that an overall picture of the used test structures and test results over time can be shown. Furthermore, this data may be presented and compared between test structure types, test structure batches, test structure manufacturers, test operators as well test persons, patient age groups, gender. This will enable to control quality, test effectiveness, overall health status and test needs.

In general, the computing resource may be configured to maintain a database, which knows the LFA tests done, test results of the tests and test conditions. In an embodiment, the database may keep record on which tests are available, or delivered to the certain area/market but are not used yet. The computing resource 110 may comprise software configured to control the computing resource 110 to store and process data to form a database and to generate various reports on the basis of the data. The database may comprise data gathered over time with test results, progress of results, progress of analysis results, progress of related care given, feedback about test results, and feedback to test readers and manufacturers. Thus, not only information on test structures and test results but also information on actions made and instructions generated on the basis of the results may be stored in the database.

The computing resource 110 may be configured to operate on tests of different manufacturers and different test readers, and many health care partners. The processed data may be shared to all relevant entities. The computing resource may be controlled by software to generate and transmit reports automatically or on demand.

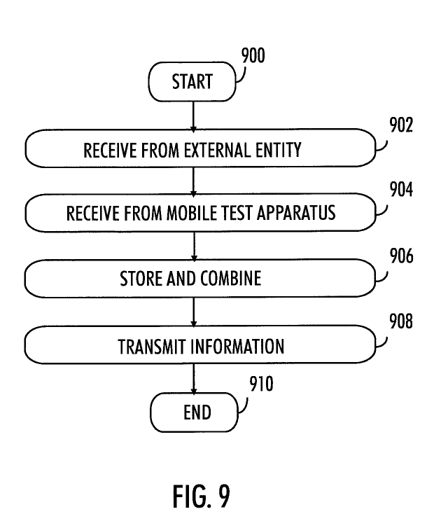

FIG. 9 is a flowchart illustrating an embodiment. The process starts at step 900.

In step 902, the computing resource 110 is configured to receive with the data communication interface 800 from at least one mobile test reader apparatus 100, information related to at least one test structure used in a lateral flow test controlled by the mobile test reader apparatus.

In step 904, the computing resource 110 is configured to receive with the data communication interface 800 from at least one external entity 104 related to the tests, analysis results and feedback related to the at least one test structure.

In step 906, the computing resource 110 is configured to store and combine information related to the at least one test structure to obtain processed data.

In step 908, the computing resource 110 is configured to transmit with the data communication interface 800 processed data to at least one external entity 104 related to tests.

The process ends in step 910.

The above process is merely an example. Additional steps may be performed before, after and amongst the above described steps. For example, the computing resource 110 may be configured to transmit information on the test structures and test results to at least one external entity 104 prior receiving analysis results and feedback from external entities.

In an embodiment, the computing resource may keep a database keeps records of each test structure or test strip by collecting and combining info related to the test structure from different sources and points.

For example, the database may comprise, for each test structure, test structure number, test structure manufacturer, test instruction, test person ID, patient ID, time data, location, test analyser and test result, for example.

Each mentioned example item may be a subset of data. For example, patient ID may contain patient name, age, gender, symptoms, and other health related info. Likewise, time data may contain set of time stamps, when the test structure has been manufactured, when it has been sent to test operator, when the test structure has been used and read, when the test result has been delivered to the computing resource, when the computing resource has delivered the results to an external entity such as an expert partner, when it has been analysed and reported back to the computing resource, when the results have been delivered to a field operator or heath care specialist to take actions for care.

In an embodiment, the computing resource may keep a database which collects feedback related to test structures from the expert partners and store and combine processed data for the test organization, test structure manufacturers and expert partners.

In an embodiment, the processed data may comprise statistical data how the tests have been used, and how they are performing. For example, the data may comprise information on how much results for a given disease (malaria, for example) are found in a certain area and the increase of found results on a daily basis in epidemic cases.

For example, the data may comprise information on how different test structures are performing related to each other, comparisons of test structures from two manufacturers or two manufacturing batches, how tests are performing in the different areas, among different patient groups, with different related symptoms and how different test readers are performing related to other test readers.

In an embodiment, the processed data may comprise feedback and possible corrective instructions for test reading instructions.

In an embodiment, the processed data may comprise information on the time data related to each tests. The computing resource 110 may be configured to follow the time stamps of the phases of different process steps.

In an embodiment, the computing resource 110 may be configured to report any delays or problems to analyse results in timely manner.

In an embodiment, the processed data may comprise information on who is processing test results and when.

In an embodiment, the computing resource 110 may be configured to automatically create reports by processing the database according to a predefined set of instructions. The computing resource 110 may be configured to create reports indicating the use of test results. For example, time information related to test results may be utilised. The computing resource 110 may be configured to filter data related to the customer (manufacturer, expert partner, authority) so that confidential information or private information which is not relevant or not allowed to share is removed, only leaving otherwise relevant statistical reference data.

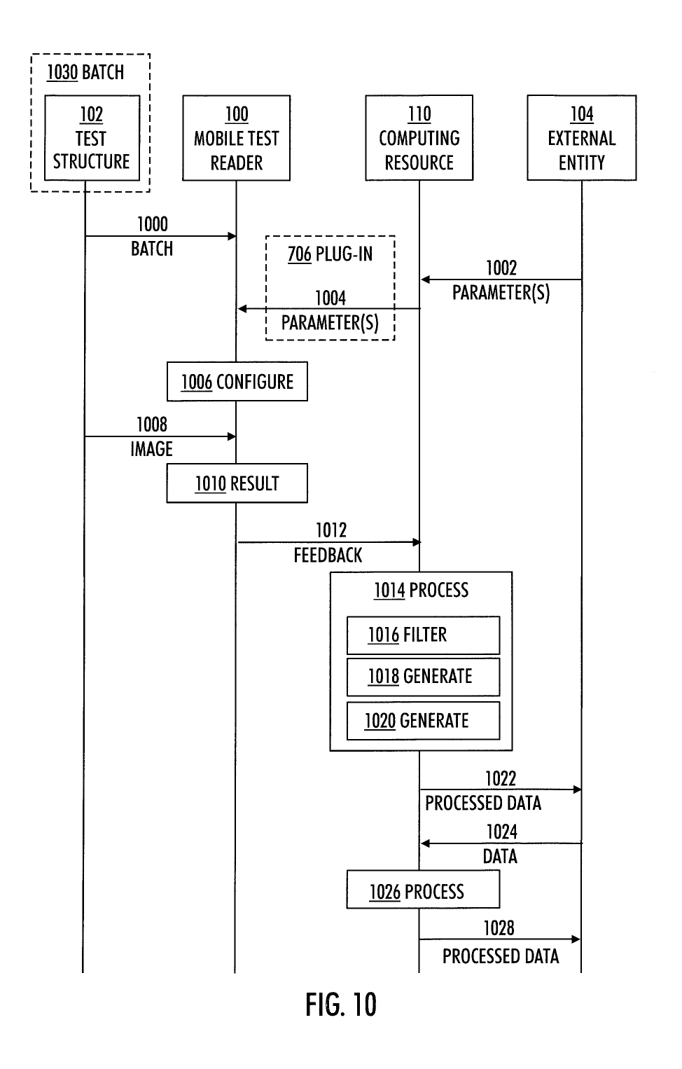

Next, with reference to FIG. 10, let us study example embodiments related to the computing resource 110 in the form of a signal sequence chart. Other functions, not described in this application, may also be executed between the operations or within the operations. Some of the operations or parts of the operations may also be left out or replaced by a corresponding operation or part of the operation. Note also that example embodiments described earlier may be used to supplement the example embodiments to be described.

The one or more memories 806 and the computer program code 804 of the computing resource 110 are configured to, with the one or more processors 802, cause the computing resource 110 to receive, from the external entity 104 related to the test 102, with the data communication interface 800, at least one parameter 1002 relating to test result generation of the test structure 102 belonging to a certain manufacturing batch 1030, and transmit, with the data communication interface 800, the at least one parameter 1004 to at least one mobile test reader apparatus 100.

The one or more memories 418 and the computer program code 412 of the mobile test reader 100 are configured to, with the one or more processors 410, cause the mobile test reader 100 to receive, from the computing resource 110, with the wireless transceiver 406, at least one parameter 1004 relating to test result generation of the test structure 102 belonging to the certain manufacturing batch 1030, configure 1006 the test reader application 502 with the received at least one parameter 1004, take, with the digital camera 402 controlled by the test reader application 502 configured with the at least one parameter 1004, image data 1008 depicting the output area 200 of the test structure 102, and transmit, with the wireless transceiver 406, feedback 1012 to the computing resource 110. The parameter 1004 comprise information on a test-specific or test structure specific plug-in 706 received from the computing resource 110.

The feedback 1012 may comprise information on test structure used, test structure number, test structure manufacturer, test instruction, test person ID, patient ID, time data, location, test analyser and test result, for example. Each mentioned example item may be a subset of data. For example, patient ID may contain patient name, age, gender, symptoms, and other health related info.

In an embodiment, the one or more memories 418 and the computer program code 412 of the mobile test reader 100 are configured to, with the one or more processors 410, cause the mobile test reader 100 to input, with the digital camera 402 or with the user interface 404, or with a wireless reading 408, information 1000 identifying the manufacturing batch 1030 of the test structure 102 to the test reader application 502.

In an embodiment, the one or more memories 418 and the computer program code 412 of the mobile test reader 100 are configured to, with the one or more processors 410, cause the mobile test reader 100 to transmit, with the wireless transceiver 406, the image data 1008 as a part of the feedback 1012.

In an embodiment, the mobile test reader 100 is configured to generate, with the test reader application 502 configured with the at least one parameter 1004, a test result 1010 for the test structure 102 on the basis of the image data 1008, and transmit, with the wireless transceiver 406, the test result 1010 as a part of the feedback 1012 to the computing resource 110.

In an embodiment, the one or more memories 806 and the computer program code 804 of the computing resource 110 are configured to, with the one or more processors 802, cause the computing resource 110 to receive, with the data communication interface 800, the feedback 1012 from the at least one mobile test reader apparatus 100 and store and process 1014 the received feedback 1012 to obtain processed data. The received feedback may be combined with previously received feedback.

In an embodiment, the one or more memories 806 and the computer program code 804 of the computing resource 110 are configured to, with the one or more processors 802, cause the computing resource 110 to perform at least one of the following: filter out 1016 private patient identifying information for the processed feedback 1022; generate 1018 summary information for the processed feedback 1022; generate 1020 quality information comparing different manufacturing batches 1030 of the test structure 102 and/or different manufacturers of the test 102 for the processed feedback 1022.

In an embodiment, the computing resource 110 is configured to transmit, with the data communication interface 800, the processed data 1022 to at least one external entity 104.

The at least one external entity 104 may be configured to further analyse the data or receive analyses from expert parties. For example, authorities, medical experts or health-care organizations may process the data and take or suggest actions on the basis of the test results, for example (not shown in the figure). For example, if a positive test result is found from a malaria test from one patient, it may cause a doctor to write treatment instructions and medical recipe. Toxic test result from a local water supply can cause actions in water supply control. Many positive results in any illness test in a certain area can cause activities to manage more intensive control and preparation for epidemic among the authorities in the area. The at least one external entity 104 may be configured to transmit data 1024 to the computing resources 110. The data may comprise external entity identification, analysis of results of a test, action suggested on the basis of the results of a test and comments related to a test, for example.

In an embodiment, the one or more memories 806 and the computer program code 804 of the computing resource 110 are configured to, with the one or more processors 802, cause the computing resource 110 to receive, with the data communication interface 800, the data 1024 from the at least one external entity 104 and store and process 1026 the received data 1012 to obtain processed data. The received data 1024 may be combined with previously received data from the at least one external entity 104 and the at least one mobile test reader apparatus 100.

In an embodiment, the computing resource 110 is configured to transmit, with the data communication interface 800, the processed data 1028 comprising information from several sources to at least one external entity 104.

Thus, the computing resource 110 is configured to receive data related to LFA test structures, tests and test related information from different sources and process the data. The computing resource 110 is configured to keep records of each test strip or structure by collecting and combining the info related to it from different sources and points and collect feedback related to test strips or structure from the external entities. The feedback may be combined with the test structure data, processed and transmitted to test organizations, test structure manufacturers and expert partners.

It will be obvious to a person skilled in the art that, as technology advances, the inventive concept can be implemented in various ways. The invention and its embodiments are not limited to the example embodiments described above but may vary within the scope of the claims.

1. A computing resource comprising
a data communication interface,
one or more processors, and
one or more memories including computer program code,
the one or more memories and the computer program code configured to, with the one or more processors, cause the computing resource at least to perform:
receive with the data communication interface from two or more mobile test reader apparatuses, information related to at least one test structure used in a lateral flow test controlled by the mobile test reader apparatus;
receive with the data communication interface from at least one external entity related to the tests, analysis results and feedback related to the at least one test structure;
store and combine information related to the at least one test structure to obtain processed data;
transmit with the data communication interface processed data to at least one external entity related to tests.

2. The computing resource of claim 1, wherein the information received from two or more mobile test reader apparatuses comprises at least one of the following: test person identification, patient identification, time information related to the test or the test structure, location of the test, identification of the mobile test reader and test results.

3. The computing resource of claim 1, wherein the information received from two or more mobile test reader apparatuses comprises at least one of the following: identifying information on the test structure.

4. The computing resource of claim 1, wherein the information received from at least one external entity related to the tests comprises at least one of the following: external entity identification, analysis of results of a test, action suggested on the basis of the results of a test, comments related to a test.

5. The computing resource of claim 2, wherein the one or more memories and the computer program code are further configured to, with the one or more processors, cause the computing resource further to perform:
store and combine information on how the test structures or test results of different locations relate to each other.

6. The computing resource of claim 3, wherein the one or more memories and the computer program code are further configured to, with the one or more processors, cause the computing resource further to perform:
store and combine information on how the test structures of different manufacturing batches of different manufacturers relate to each other.

7. The computing resource of claim 1, wherein the one or more memories and the computer program code are further configured to, with the one or more processors, cause the computing resource further to perform: filter out private patient identifying information before combining information to obtain processed data.

8. The computing resource of claim 1, wherein the one or more memories and the computer program code are further configured to, with the one or more processors, cause the computing resource further to perform: process information of combined information related to a set of tests or test structures selected on the basis of a given criteria.

9. The computing resource of claim 8, wherein the given criteria is one or more of the following: location, time of the test, test type, test structure type, test reader, test structure manufacturer.

10. The computing resource of claim 1, wherein the one or more memories and the computer program code are further configured to, with the one or more processors, cause the computing resource further to perform: generate on the basis of received information an update to one or more parameters used by a mobile test reader apparatus when controlling a test.

11. The computing resource of claim 4, wherein the one or more memories and the computer program code are further configured to, with the one or more processors, cause the computing resource further to perform: obtain information of entities processing test results and related timing information and generate on the basis of information report of test result processing.

12. The computing resource of claim 1, wherein the one or more memories and the computer program code are further configured to, with the one or more processors, cause the computing resource further to perform: generate on the basis of received information update to test result interpretation instructions.

13. The computing resource of claim 1, wherein the one or more memories and the computer program code are further configured to, with the one or more processors, cause the computing resource further to perform: generate on the basis of received information processed data on timing information related to tests and the usage of test structures.

14. The computing resource of claim 1, configured to communicate with an external entity related to the tests, wherein the external entity comprises one or more computing resources controlled by at least one of the following: a manufacturer of the mobile test reader apparatus, a distributor of the mobile test reader apparatus, a manufacturer of the test, a distributor of the test, a health-care organization, a service provider.

15. A method, comprising:
receiving from two or more mobile test reader apparatuses, information related to at least one test structure used in a lateral flow test controlled by the mobile test reader apparatus;
receiving from at least one external entity related to the tests, analysis results and feedback related to the at least one test structure;
storing and combining information related to the at least one test structure to obtain processed data;
transmitting processed data to at least one external entity related to tests.
